(19) United States
(12) Patent Application Publication
(10) Pub. No.: US 2015/0027241 A1
(43) Pub. Date: Jan. 29, 2015

(54) PIERCING PROBES WITH OFFSET CONICAL PIERCING TIP AND FLUID-SAMPLING SYSTEMS COMPRISING THE PIERCING PROBES

(71) Applicant: DIBA INDUSTRIES, INC., Danbury, CT (US)

(72) Inventors: Kevin Domkofski, Danbury, CT (US); John LaVia, Danbury, CT (US); Jose Almeida, Danbury, CT (US)

(73) Assignee: DIBA INDUSTRIES, INC., Danbury, CT (US)

(21) Appl. No.: 14/338,887

(22) Filed: Jul. 23, 2014

Related U.S. Application Data
(60) Provisional application No. 61/857,461, filed on Jul. 23, 2013.

(51) Int. Cl. G01N 1/14

(52) U.S. Cl. CPC G01N 1/14
USPC 73/863.81; 73/866.5

(57) ABSTRACT

Piercing probes for fluidic applications may include a body portion including a distal end of the piercing probe. The piercing probes may also include a piercing portion opposite the distal end of the piercing probe. The piercing portion may include a conical portion, which may include a piercing tip. The piercing probe may also include a continuous lumen defined through the body portion and the piercing portion. The continuous lumen may be centered about a primary longitudinal axis of the piercing probe. A longitudinal tip axis may be defined through the piercing tip parallel to the primary longitudinal axis. The longitudinal tip axis may be offset from the primary longitudinal axis by an offset distance greater than zero. Fluid-sampling systems including the piercing probes may further include a device configured to draw or expel fluid through the continuous lumen.

### CROSS-REFERENCES TO RELATED APPLICATIONS

This application claims the benefit of priority under 35 U.S.C. §119(e) to U.S. Provisional Application Ser. No. 61/857,461, filed Jul. 23, 2013.

### TECHNICAL FIELD

The present specification relates generally to piercing probes and fluid-sampling systems and, more particularly, to piercing probes having offset conical piercing tips to avoid coring and sealing during the fluidic applications and to fluid-sampling systems comprising the piercing probes.

### BACKGROUND

Fluid samples requiring analysis may be stored in containers such as tubes or vials that are sealed with a septum, a foil, or a membrane that isolates the fluid sample from the environment. When the fluid samples are prepared to be analyzed by some applications, a probe of suitable diameter must be pierced through the septum, foil, or membrane so that the fluid sample can flow through a tip of the probe and out a distal end of the probe. With some designs of probes, during the piercing a small piece of the septum, foil, or membrane can become lodged in the entrance at the tip of the probe, thereby either clogging the probe entirely or adversely affecting the ability to analyze the fluid sample efficiently or accurately. This phenomenon is known as “coring.” Additionally, it is desirable for fluidic probes to have end profiles that prevent sealing of the probe against a flat bottom of containers, a particular problem that occurs when fluids are withdrawn from the containers by suction force. There remain ongoing needs for piercing probes for fluidic applications that avoid or eliminate coring and also do not seal against container bottoms.

### SUMMARY

Against the above background, embodiments disclosed herein are directed to piercing probes for fluidic applications. The piercing probes may include a body portion including a distal end of the piercing probe and having a width that defines an outside diameter of the piercing probe. The piercing probes may also include a piercing portion opposite the distal end of the piercing probe. The piercing portion may include a conical portion, which may include a piercing tip. The piercing probe may also include a continuous lumen defined through the body portion and the piercing portion from a distal opening at the distal end of the piercing probe to a proximal opening of the piercing probe in the piercing portion. The continuous lumen may have a width that defines an inside diameter of the piercing probe. The continuous lumen may be centered about a primary longitudinal axis of the piercing probe. A longitudinal tip axis may be defined through the piercing tip parallel to the primary longitudinal axis. The longitudinal tip axis may be offset from the primary longitudinal axis by an offset distance greater than zero or equal to or greater than one-half the inside diameter plus 5% of the inside diameter.

Further embodiments disclosed herein are directed to fluid sampling systems including a piercing probe as described above and further including a fluid-transfer device in fluidic communication with the distal opening of the body portion. The fluid transfer device is configured to draw fluid through the continuous lumen and out the distal opening or to expel fluid through the continuous lumen and out of the proximal opening. In illustrative embodiments, the fluid transfer device may be a syringe, for example.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic illustration of an embodiment of a piercing probe described herein;

FIG. 2 is a perspective view of a piercing portion of a piercing probe according to some embodiments herein;

FIG. 3A is a front view of the piercing portion of FIG. 2;

FIG. 3B is a back view of the piercing portion of FIGS. 2 and 3A;

FIG. 4 is a side view of the piercing portion of FIGS. 2, 3A, and 3B;

FIG. 5 is a perspective view of a piercing portion of a piercing probe according to some embodiments herein, distinguished from that of FIG. 2 by the cutting angle used to form the piercing portion; and

FIG. 6 is a side view of the piercing portion of FIG. 5; and

FIG. 7 is a schematic of an exemplary fluid sampling system including a piercing probe according to embodiments herein.

### DETAILED DESCRIPTION

References will now be made in detail to embodiments of piercing probes and fluid sampling systems including the piercing probes. The piercing probes according to embodiments herein may be non-coring and may include additional benefits and advantages that will be described. In some embodiments, the piercing probes may include a conical tip aligned along a longitudinal tip axis that is offset from a primary longitudinal axis of the piercing probe.

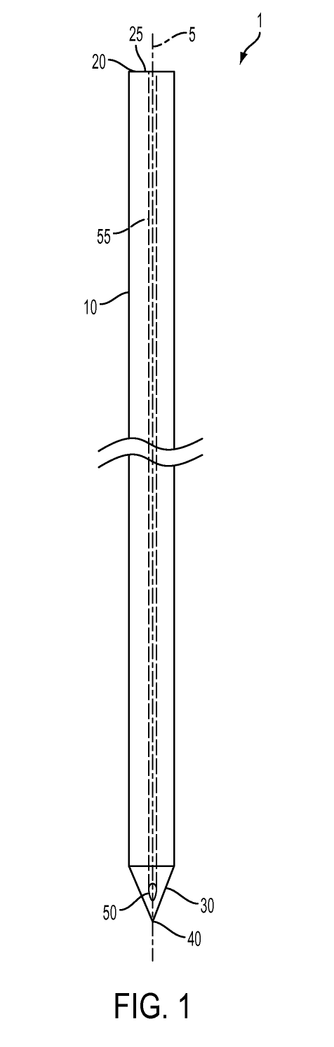

Referring to the schematic depiction in FIG. 1, a piercing probe 1 for fluidic applications may include a body portion 10, a piercing portion 30, and a continuous lumen 55. The body portion 10 may include a distal end 20 of the piercing probe 1. The piercing portion 30 of the piercing probe 1 is opposite the distal end 20 of the piercing probe 1 and includes a conical portion having a piercing tip 40. The continuous lumen 55 is defined through both the body portion 10 and the piercing portion 30 from a distal opening 25 at the distal end 20 of the piercing probe 1 to a proximal opening 50 of the piercing probe 1 in the piercing portion 30. In some embodiments, the body portion 10 may be a cylindrical or substantially cylindrical tube and the continuous lumen 55 defined through the body portion 10 may also be substantially cylindrical. The body portion 10 may have a primary longitudinal axis 5. The primary longitudinal axis 5 may be the rotational axis of symmetry of the body portion 10. The primary longitudinal axis 5 may also be a rotational axis of symmetry of the continuous lumen 55, such that the continuous lumen 55 is centered about the primary longitudinal axis 5. In this regard, in some embodiments the rotational axes of symmetry of the body portion 10 and the continuous lumen 55, may be collinear. If the body portion 10 is cylindrical, for example, the body portion 10 and the continuous lumen 55 may be concentric. The piercing tip 40 is offset from the primary longitudinal axis 5 of the body portion 10 by an offset distance greater than zero, as will be described in greater detail below.

According to some embodiments, the piercing probe 1 may be constructed from any material for transporting fluids that has a rigidity sufficient to enable the piercing tip 40 to pierce a material such as a septum, a foil, or a membrane, for example. In some embodiments, the piercing probe 1 may be a rigid tube generally without bends. In other embodiments, the piercing probe 1 may be substantially rigid but capable of some flexibility. Exemplary materials for the piercing probe 1 may include plastics, polymers, and metals. In a nonlimiting specific embodiment, the piercing probe 1 may be formed of a plastic such as PolyEtherEtherKetone (PEEK) or a metal such as various grades of steel (stainless steel, for example). Though the embodiments of the piercing probe 1 described herein are expected to show great benefit for small-volume fluidic systems including tubing in fluidic communication with the piercing probe 1 and having outside diameters such as 0.125 inches (3.4 mm), it is contemplated that the piercing end contours of the piercing probes described herein may have utility even for microfluidic applications using tubing having outside diameters of less than 1 mm or for larger-scale applications with tubing outside diameters up to 3 cm.

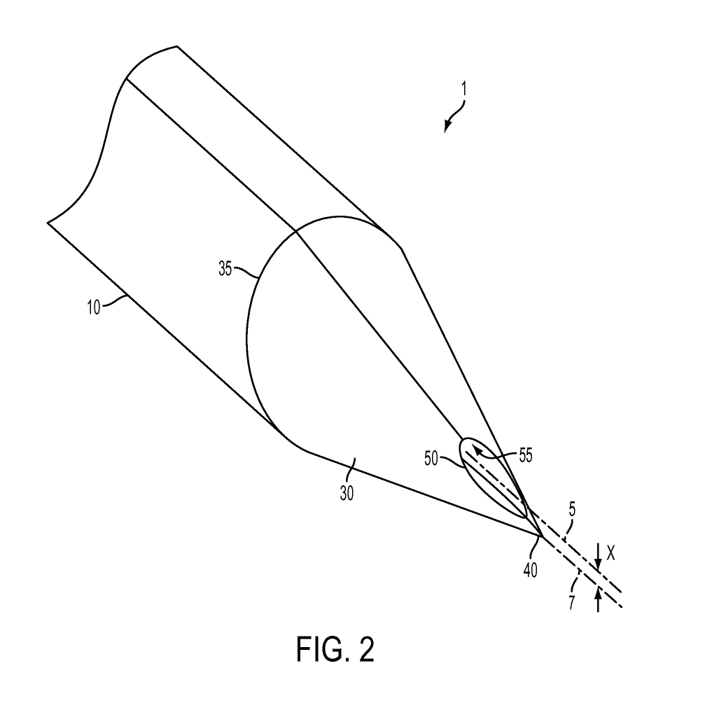

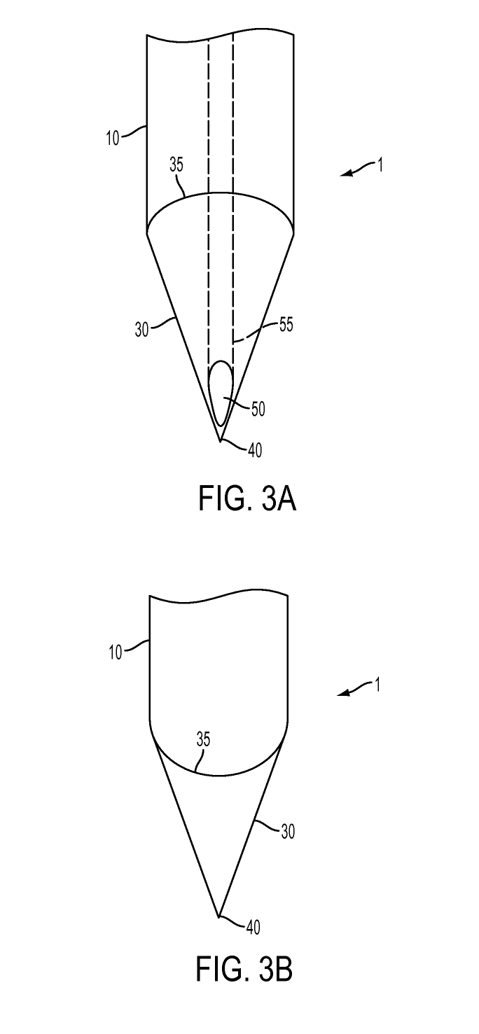

Referring to the detail perspective view of FIG. 2, the front view of FIG. 3A, and the back view of FIG. 3B, the piercing portion 30 of the piercing probe 1 may have a slanted curved edge 35 at an intersection of the piercing portion 30 with the body portion 10. The precise geometric contour of the piercing portion 30 may result from a grinding or cutting technique used to form the piercing portion 30 at one end of the body portion 10 which, before the piercing portion 30 is formed, may be substantially cylindrical, for example. To machine the piercing portion 30 of FIG. 2 onto a substantially cylindrical tube, the tube may be held in an offset collet of a rotary tool while the body portion 10 is ground or cut at a predetermined angle as the offset collet is rotated. As an illustration, in a customary drill, a tube would be held in a collet configured such that the tube rotates about its rotational axis of symmetry. If a tube were cut at an angle using a customary drill of this type, the machining would produce a strictly conical cut at the end of the tube having a hypothetical apex, which would be positioned directly over the center of the tube if the tube did not contain a lumen. In contrast to grinding or cutting the customary drill that rotates the tube around its rotational axis of symmetry, the offset collet rotates the tube around a different axis. In particular, to form the piercing probe 1 of FIG. 2, the offset collet is configured with an offset distance that causes the tube to rotate about an intended position of a longitudinal tip axis parallel to the rotational axis of symmetry of the tube at an intended position for the piercing tip. Thus, for the exemplary embodiment of the piercing probe 1 of FIG. 2, for example, such the tube may be held in a collet offset by the predetermined offset distance and cut at an angle of 20° while the offset collet rotates. The resulting piercing portion 30 thereby acquires a piercing tip 40 that is offset from the proximal opening 50 of the continuous lumen 55. Additional aspects of the geometry of the piercing tip 40 will be described in greater detail below.

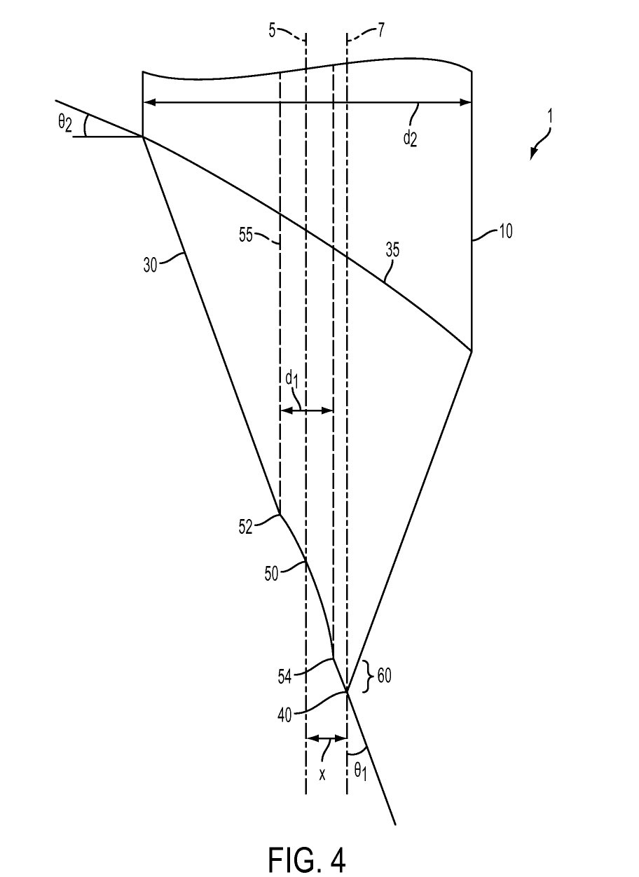

Referring to the side view of FIG. 4, a longitudinal tip axis 7 is defined through and extends from the piercing tip 40 in a direction parallel to the primary longitudinal axis 5 of the body portion 10. The longitudinal tip axis 7 is separated from the primary longitudinal axis 5 by an offset distance x. The primary longitudinal axis 5 is the rotational axis of symmetry for both the body portion 10, which has a width that defines an outside diameter d₂ of the piercing probe 1, and the continuous lumen 55, which has a width that defines an inside diameter d₁ of the piercing probe 1.

When viewed from the side as in FIG. 4, the proximal opening 50 of the continuous lumen 55 has a first end 52 farthest from the piercing tip 40 and a second end 54 nearest to the piercing tip 40. The piercing portion 30 may include a conical portion 60, and the conical portion includes the piercing tip 40 as its apex. The conical portion 60 may be defined as a portion of the piercing portion 30 from the second end 54 of the proximal opening to the piercing tip 40. Thus, the conical portion 60 is a right circular cone having the longitudinal tip axis 7 as its axis and the piercing tip 40 as its apex. It follows that every cross section of the conical portion 60 cut with a plane perpendicular to the longitudinal tip axis 7 is circular when the body portion 10 of the piercing probe 1 is cylindrical. The offset distance x may be chosen during fabrication of the piercing probe 1 based on the configuration of the offset collet. In general, the offset distance x is greater than zero. In exemplary embodiments, the offset distance x may be equal to or greater than one-half the inside diameter plus 5% of the inside diameter (i.e., x≧(d₁/2)+0.05d₁). In further exemplary embodiments, the offset distance x may range from one-half the inside diameter d₁ plus 5% of the inside diameter d₁ to about 95% of one-half the outside diameter d₂ (i.e., (d₁/2)+0.05d₁≧x≧0.95(d₂/2). The longitudinal tip axis 7 passes through the body portion 10 between inner walls of the piercing probe 1 that define the continuous lumen 55 and outer walls of the piercing probe 1 that define the outside diameter d₂ of the piercing probe 1.

The piercing portion 30 has a slant angle θ₁ defined between the longitudinal tip axis 7 and line extended from the slope of the conical portion 60 through the piercing tip 40. The slanted curved edge 35 of the piercing portion 30 is slanted at an edge angle θ₂ with respect to a line perpendicular to the primary longitudinal axis 5. Both the slant angle θ₁ and the edge angle θ₂ may result from an angle at which the probe body is cut during machining in an offset collet, as described above. In some embodiments, the slant angle θ₁ of the piercing tip 40 is congruent with the edge angle θ₂ of the slanted curved edge 35. In the embodiment of FIG. 4, the slant angle θ₁ and the edge angle θ₂ are approximately 20°. Nevertheless, it should be understood that the slant angle θ₁ may be varied as desired. In other embodiments, slant angle θ₁ may range from about 5° to about 60°, such as from about 10° to about 50°. In general, the smaller the slant angle θ₁, the sharper the piercing tip 40. It should be understood that smaller slant angles may be desirable when the piercing probe 1 is intended for use in piercing certain materials such as thick rubbers, while larger slant angles may be desirable for piercing other materials such as soft membranes.

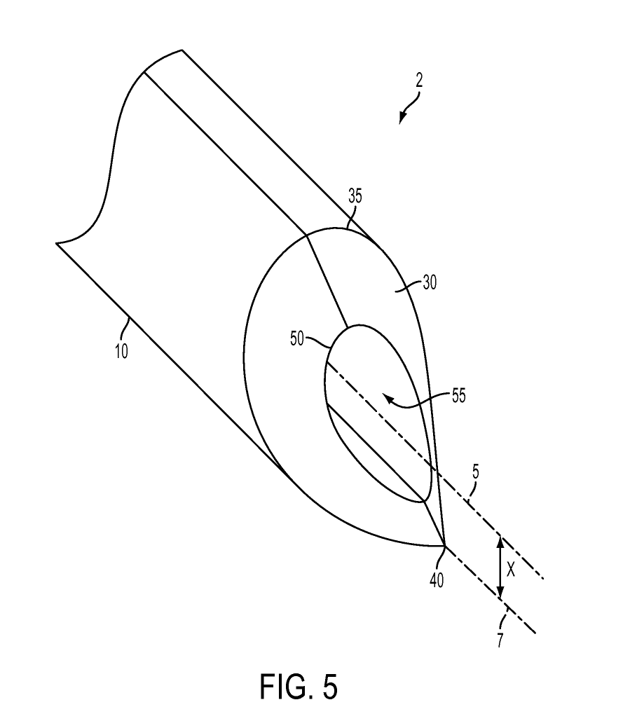

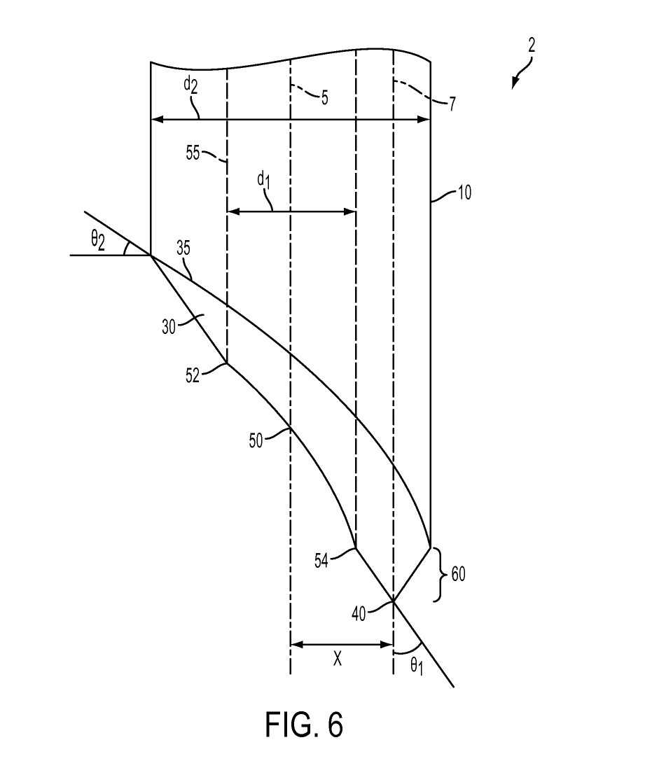

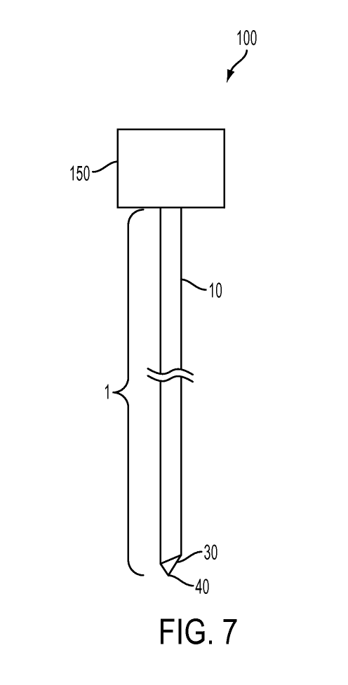

As an example of the effect of varying the slant angle θ₁, and additional exemplary embodiment of a piercing probe, in particular, a large-angle piercing probe 2, is illustrated in FIGS. 5 and 6. The large-angle piercing probe 2 may be formed by the same techniques described above for forming the piercing probe 1 of FIGS. 1-4. The large-angle piercing probe 2 of FIGS. 5 and 6 has a slant angle θ₁ of approximately 35°, compared to the approximately 20° of the piercing probe 1 of FIGS. 1-4. As in the piercing probe 1 of FIGS. 1-4, in the large-angle piercing probe 2 of FIGS. 5 and 6 a longitudinal tip axis 7 extends from the piercing tip 40 in a direction parallel to the primary longitudinal axis 5 of the body portion 10 and is separated from the primary longitudinal axis 5 by an offset distance x. The primary longitudinal axis 5 is the rotational axis of symmetry for both the body portion 10, having an outside diameter d₂, and the continuous lumen 55, having an inside diameter d₁. The proximal opening 50 of the continuous lumen 55 has a first end 52 farthest from the piercing tip 40 and a second end 54 nearest to the piercing tip 40. A conical portion 60 may be defined as a portion of the piercing portion 30 from the second end 54 of the proximal opening to the piercing tip 40. The conical portion 60 is a right circular cone having the longitudinal tip axis 7 as its axis. Thus, any cross section of the conical portion 60 cut with a plane perpendicular to the longitudinal tip axis 7 is circular. In the embodiment of FIGS. 5 and 6, the offset distance x is approximately 0.25×(d₂−d₁), such that the piercing tip 40 is disposed halfway between the second end 54 of the proximal opening 50 and the outer wall of the body portion 10, that is, halfway between the continuous lumen 55 and the outer wall of the body portion 10.

It should be understood that the piercing probe configurations described herein are meant to be exemplary only and that numerous additional embodiments are contemplated. By varying material, axis offset and angle of cut as described above, different geometries that perform the same functions can be achieved. Given a starting material geometry, varying the axis offset will allow the piercing tip to be formed within the wall of the tubing. Varying the angle of the cut will allow for changes in the force required to pierce a given membrane (decreasing the angle theoretically decreases the force) and to create a sharper tip. Also, by varying the angle, the tip life and strength can be affected.

Having described above various non-limiting embodiments of piercing probes, such as the piercing probe 1 of FIGS. 1-4 and the large-angle piercing probe 2 of FIGS. 5 and 6, fluid sampling systems including the piercing probes now will be described with reference additionally to FIG. 6.

Referring to FIGS. 1-6, and with particularity to FIG. 6, a fluid-sampling system 100 may include a piercing probe 1 and a fluid-transfer device 150. It should be understood that the piercing probe 1 of the fluid-sampling system 100 may be a piercing probe according to any embodiment described above, not limited merely to the exemplary embodiments shown and described in FIGS. 1-5.

The piercing probe 1 of the fluid-sampling system 100 may include a body portion 10 including a distal end 20 of the piercing probe 1. The body portion 10 may have a width that defines an outside diameter d₂ of the piercing probe 1. The piercing probe 1 may further include a piercing portion 30 opposite the distal end 20 of the piercing probe 1. The piercing portion 30 may comprise a conical portion 60 having a piercing tip 40. A continuous lumen 55 may be defined through the body portion 10 and the piercing portion 30 from a distal opening 25 at the distal end 20 of the piercing probe 1 to a proximal opening 50 of the piercing probe 1 in the piercing portion 30. The continuous lumen 55 may have a width that defines an inside diameter d₁ of the piercing probe 1. The continuous lumen 55 may be centered about a primary longitudinal axis 5 of the piercing probe 1. A longitudinal tip axis 7 may be defined through the piercing tip 40 parallel to the primary longitudinal axis 5. The longitudinal tip axis 7 is offset from the primary longitudinal axis 5 by an offset distance x greater than zero such as, for example, equal to or greater than one-half the inside diameter d₁ plus 5% of the inside diameter d₁; from about one-half the inside diameter d₁ plus 5% of the inside diameter d₁ to about 95% of one-half the outside diameter d₂ of the body portion; or approximately 0.25 times the difference of the outside diameter d₂ and the inside diameter d₁.

The fluid sampling system 100 further may include a fluid-transfer device 150 in fluidic communication with the distal opening 25 of the piercing probe 1. The fluid-transfer device 150 may be configured to draw fluid through the continuous lumen 55 and out the distal opening 25 or to expel fluid through the continuous lumen 55 and out of the proximal opening 50. In exemplary embodiments, the fluid-transfer device 150 may be a syringe, a vacuum apparatus, or any fluidic device that requires drawing or expelling a fluid through the piercing probe 1. During sampling of a fluid using the fluid-sampling system 100, the piercing tip 40 of the piercing probe 1 may be used to pierce through a septum or membrane, for example, which covers a fluid sample inside a fluid container such as a vial or bottle. When the septum or membrane is pierced, the proximal opening 50 of the piercing probe 1 will not be blocked due to coring of the septum or membrane. Additionally, if during the sampling procedure the piercing probe 1 is extended to the bottom of the fluid container, the conical configuration of the piercing tip 40 will prevent the proximal opening 50 from sealing against the bottom of the fluid container.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

It is noted that terms like “preferably,” “commonly,” and “typically” are not utilized herein to limit the scope of the appended claims or to imply that certain features are critical, essential, or even important to the structure or function of the claimed subject matter. Rather, these terms are merely intended to highlight alternative or additional features that may or may not be utilized in a particular embodiment.

What is claimed is:

1. A piercing probe for fluidic applications, the piercing probe comprising:
a body portion including a distal end of the piercing probe, the body portion having a width that defines an outside diameter of the piercing probe;
a piercing portion opposite the distal end of the piercing probe, the piercing portion comprising a conical portion having a piercing tip; and
a continuous lumen defined through the body portion and the piercing portion from a distal opening at the distal end of the piercing probe to a proximal opening of the piercing probe in the piercing portion, the continuous lumen having a width that defines an inside diameter of the piercing probe,
wherein:
the continuous lumen is centered about a primary longitudinal axis of the piercing probe;
a longitudinal tip axis is defined through the piercing tip parallel to the primary longitudinal axis; and
the longitudinal tip axis is offset from the primary longitudinal axis by an offset distance greater than zero.

2. The piercing probe of claim 1, wherein the offset distance is equal to or greater than one-half the inside diameter plus 5% of the inside diameter.

3. The piercing probe of claim 1, wherein the offset distance is from about one-half the inside diameter plus 5% of the inside diameter to about 95% of one-half the outside diameter of the body portion.

4. The piercing probe of claim 1, wherein the offset distance is approximately 0.25 times the difference of the outside diameter and the inside diameter.

5. The piercing probe of claim 1, wherein the body portion and the continuous lumen both are substantially cylindrical.

6. The piercing probe of claim 1, wherein an intersection of the piercing portion and the body portion defines a slanted curved edge.

7. The piercing probe of claim 1, wherein:
the conical portion slopes from the piercing tip toward the continuous lumen at a slant angle;
the slanted curved edge of the piercing portion is slanted at an edge angle with respect to a line perpendicular to the primary longitudinal axis; and
the slant angle is congruent to the edge angle.

8. The piercing probe of claim 7, wherein the slant angle of the piercing portion is from about 5° to about 60°.

9. The piercing probe of claim 1, wherein the primary longitudinal axis is disposed between a first end of the proximal opening farthest from the piercing tip and a second end of the proximal opening closest to the piercing tip.

10. The piercing probe of claim 1, wherein the conical portion is a right circular cone having the longitudinal tip axis as a rotational axis of symmetry, whereby every cross section of the conical portion cut with a plane perpendicular to the longitudinal tip axis is circular.

11. The piercing probe of claim 1, wherein the primary longitudinal axis is a rotational axis of symmetry of both the body portion and the continuous lumen.

12. The piercing probe of claim 1, wherein the piercing probe is formed from a material chosen from plastics, polymers and metals.

13. The piercing probe of claim 1, wherein the piercing probe is formed PEEK or stainless steel.

14. The piercing probe of claim 1, wherein the piercing portion is formed by machining a cylindrical tube in an offset collet and cutting the cylindrical tube at an angle while the offset collet rotates the cylindrical tube about an axis intended to be the longitudinal tip axis.

15. A fluid sampling system comprising:
a piercing probe comprising:
a body portion including a distal end of the piercing probe, the body portion having a width that defines an outside diameter of the piercing probe;
a piercing portion opposite the distal end of the piercing probe, the piercing portion comprising a conical portion having a piercing tip; and
a continuous lumen defined through the body portion and the piercing portion from a distal opening at the distal end of the piercing probe to a proximal opening of the piercing probe in the piercing portion, the inner wall of the continuous lumen having a width that defines an inside diameter of the piercing probe,
wherein:
the continuous lumen is centered about a primary longitudinal axis of the piercing probe;
a longitudinal tip axis is defined through the piercing tip parallel to the primary longitudinal axis; and
the longitudinal tip axis is offset from the primary longitudinal axis by an offset distance greater than zero; and
a fluid-transfer device in fluidic communication with the distal opening of the piercing probe, the fluid transfer device configured to draw fluid through the continuous lumen and out the distal opening or to expel fluid through the continuous lumen and out of the proximal opening.

16. The fluid sampling system of claim 15, wherein the fluid-transfer device comprises a syringe or a vacuum apparatus.

17. The fluid sampling system of claim 15, wherein the offset distance is equal to or greater than one-half the inside diameter plus 5% of the inside diameter.

18. The fluid sampling system of claim 15, wherein the offset distance is from about one-half the inside diameter plus 5% of the inside diameter to about 95% of one-half the outside diameter of the body portion.

19. The fluid sampling system of claim 15, wherein the offset distance is approximately 0.25 times the difference of the outside diameter and the inside diameter.
